(19) United States
(12) Patent Application Publication
(10) Pub. No.: US 2009/0257566 A1
(43) Pub. Date: Oct. 15, 2009

(54) SYSTEMS AND METHODS FOR ACCESSING INFORMATION CONTENT WHILE HOLDING ON A TELEPHONE CALL

(76) Inventor: Jonathan Dixon, Lafayette, CA (US)

Correspondence Address: Matlock Law Gfoup, PC, 1485 Treat Blvd., Suite #200, Walnut Creek, CA, 94597, US

(21) Appl. No.: 12/102,658

(22) Filed: Apr. 14, 2008

(51) Int. Cl. H04M 1/64

(52) U.S. Cl. 379/88.04

(57) ABSTRACT

Systems and methods are introduced for accessing information content while holding on a telephone call. Instructions provide an automated message voice recognition menu selection system when a caller is placed on hold. A spoken voice recognition response unit associates a category context and, responsive to the user category selection, provides one or more information content titles representing information files including fractional samples of information content. Sales data and critic reviews of the information content via a streaming data page is uploaded into the user instance of the system. The streaming data page is a fractional, recognizable portion of a song. A context based artificial intelligence voice recognition systems further interacts with the user while holding on a telephone call subsequently playing at least a portion of a user selected title unless the user returns to the previous menu or terminates the service to complete the held call.

### BACKGROUND

The present invention relates generally to systems and methods for accessing information content while holding on a telephone call.

There is a large market for automated features and services while a caller holds on a telephone call. In general, advertising and marketing messages played to a user are well known in the industry. However, many of these approached request that a caller respond with a manual inquiry of a customer service representative of the company where the call is to be connected. However, if the caller forgets to ask at the end of the call or simply runs out of time once done dealing with the subject of the original telephone call, an opportunity to make a sale is lost.

Many systems in practice are closely tied to offering products and services offered by the type of business owing the phone line. For instance, an electronics chain may offer the opportunity for pay-per-incident premium technical support. In another example, a satellite TV service provider may offer the ability to speak to a live agent to select a satellite service package for a fee rather than using an automated message system, and charging that premium service to the customer's next monthly bill. Not all types of businesses, however, have goods or services that can be offered for hire or purchase in a telephone menu system. Yet, most businesses must staff in such a manner that customers and clients are inevitably required to wait on hold at some point in the business day.

Depending on the type business, some clients may experience significant hold times. This results in frustration and a feeling of idleness for clients; it also results in lost business opportunities for companies with clients waiting on hold. The key to reducing client frustration with long waits is diversion. Indeed, some amusement parks go to great lengths to employ experts to design very extensive wait queues for new and popular attractions that divert visitors' attention from the fact that they are waiting in line; the queue itself becomes an interesting attraction.

The present invention discloses a system and methods to address this problem, much like a well-designed amusement park queue. The system offers user-selectable music on hold; it is interactive, offering services such as playing selected tracks, listening to critical reviews, and purchasing desired tracks. At the same time that customers on hold are being entertained, such a system opens up the possibility of generating sales revenues for the company hosting the service.

### SUMMARY OF THE INVENTION

In certain aspects, the invention is directed to systems and methods for accessing information content while holding on a telephone call. In other embodiments, systems and methods are provided for sampling and selling information content, such as music, via a telephone call on hold which utilizes a telecommunications system with automated voice prompt software for callers placed on hold that are subscribing members. The system plays abbreviated samples of Billboard chart toppers or other user selected information content and then prompts a caller to either play other selections or purchase a selection at which point the caller is prompted for payment and shipping information.

According to one embodiment, a method of providing user selectable information content while holding on a telephone call comprises providing an automated message voice recognition menu selection system; activating said system when a caller is placed on hold; directly providing at least one category of user selectable information content; directly receiving a spoken voice recognition response by the caller; associating a user selectable information content category context to said spoken voice recognition response; providing a user selectable context category selection means in response to said spoken voice recognition response; responsive to said category selection, providing one or more information content titles wherein said content titles represent information files including fractional samples of information content; and responding to a caller selection of a first information content files, playing said information content sample associated with said first information content tile for a predetermined period of time wherein said first information content title may be terminated early at the option of the caller and a subsequent information content title may be selected and the associated sample be played.

A computer readable medium embodiment further comprises program code for providing user selectable information content while holding on a telephone call comprises providing an automated message voice recognition menu selection system; activating said system when a caller is placed on hold; directly providing at least one category of user selectable information content; directly receiving a spoken voice recognition response by the caller; associating a user selectable information content category context to said spoken voice recognition response; providing a user selectable context category selection means in response to said spoken voice recognition response; responsive to said category selection, providing one or more information content titles wherein said content titles represent information files including fractional samples of information content; and responding to a caller selection of a first information content file, playing said information content sample associated with said first information content title for a predetermined period of time wherein said first information content title may be terminated early at the option of the caller and a subsequent information content title may be selected and the associated sample be played.

In another embodiment, a client system comprises a processor and a computer readable medium wherein the processor executes the program code.

Another embodiment comprises a computer system for providing user selectable information content while holding on a telephone call. The system includes a memory containing predetermined instructions and one or more data structures, a processing unit operatively coupled to the memory and capable of executing the predetermined instructions, an output device operatively coupled to the memory and the processing unit. The system is further configured wherein the processing unit executes the predetermined instructions for providing an automated message voice recognition menu selection system; activating said system when a caller is placed on hold; directly providing at least one category of user selectable information content; directly receiving a spoken voice recognition response by the caller; associating a user selectable information content category context to said spoken voice recognition response; providing a user selectable context category selections means in response to said spoken voice recognition response; responsive to said category selection, providing one or more information content titles wherein said content titles represent information files including fractional samples of information content; and responding to a caller selection of a first information content file, playing said information content sample associated with said first information content title for a predetermined period of time wherein said first information content title may be terminated early at the option of the caller and a subsequent information content title may be selected and the associated sample be played.

In another embodiment, a method comprises the additional steps of responding to a caller selection of a first information content file; and playing said information content sample or entire title associated with said first information content title for a predetermined period of time wherein said first information content title may be terminated early at the option of the caller and a subsequent information content title may be selected and the associated sample may be played.

In another aspect of the previous embodiment, a method of providing user selectable information content while holding on a telephone call further includes the steps of guiding a caller to enter billing and shipping information upon a decision to buy; and terminating any of the selected information content files when the call is transferred to the intended meantime available recipient on demand of the caller.

In another aspect of the previous embodiment, a method of providing user selectable information content while holding on a telephone call further includes the steps of receiving and interactive voice recognition automated message set; and transmitting a keypad touch message set in response to an interactive recognition automated message set.

In another aspect of the previous embodiment, a method of providing user selectable information content while holding on a telephone call further includes the steps of providing the automated message voice recognition menu selection system while a user is on hold during a telephone call wherein said system is communicatively linked to a streaming data page tracking data, including information content sales and critic reviews of said information content, said streaming data page that is capable of being uploaded into the user instance of the system.

In another embodiment, a computer-implemented apparatus for providing user selectable information content while holding on a telephone call comprises a processor; an input device coupled to the processor by inputting the selection (by way of illustration only, such as a number keypad or a voice activated menu selection); a memory coupled to the processor, an execution engine including instructions executable by the processor, the instructions being configured for providing user selectable information content while holding on a telephone call, and an output device for playing the user selected information content files while holding on a telephone call.

In another aspect of the previous embodiment, a method of providing user selectable information content while holding on a telephone call further includes the steps of providing the streaming data page automatically into a user instance of the system.

### BRIEF DESCRIPTION OF DRAWINGS

FIG. 1 illustrates a system for implementing methods of accessing information content samples while holding on a telephone call.

FIG. 2 illustrates an embodiment of the overall process for providing a method of accessing information content samples while holding on a telephone call.

FIG. 3 illustrates an embodiment including a method for providing titles to a caller placed on hold by providing an artificial intelligence module in an automated message voice recognition menu system.

FIG. 4 illustrates an embodiment including a method for playing at least a subset of a information content file.

FIG. 5 illustrates an embodiment including a method to provide uploaded streaming data selection marketing features for providing a subsequent category and title selection means.

FIG. 6A illustrates an embodiment of a method to communicatively link an automated message voice recognition menu selection system to a user instance streaming data page.

FIG. 6B illustrates an embodiment of a method to verify titles for purchase.

FIG. 7 shows an embodiment of a method to associate a user instance of content with a streaming data page for electronically presenting a selected title for purchase.

FIG. 8 shows an embodiment of a method for providing a context based artificial intelligence voice recognition interaction during the holding period of a telephone call and playing at least a portion of the selection prior to connecting the call.

### DETAILED DESCRIPTION

The user of the system of the present invention can be an administrator or a caller; however, since most users will be callers, the terms “user” and “caller” will be synonymous in this description unless otherwise noted, and the use of the term “user” in reference to an administrator will be limited to references to “user-specific” instances of a module, data-stream or account parameters as the use term “user specific” is very common in the art to describe a number of types of users. Every attempt is made by Applicant in every case to clearly identify which type of user is being discussed when this term “user-specific” is used. Additionally, a “streaming data page” is understood throughout the present Application to refer to a data stream to be interpreted as an audio signal only, with no visual component.

The detailed description that follows uses an example of a caller contacting a doctor's office, who is placed on hold while waiting for an attendant by an automated switchboard in order to illustrate the exemplary embodiments of the system of the present invention. The use of this very specific scenario is not intended to limit the system described in detail herein to applications of phone systems only in the medical services market. On the contrary, Applicant's disclosed invention can be applied to a multiplicity of markets, at any size of business wishing to have services providing music and/or messages while callers are on hold. Further, the embodiments described in this section illustrate but do not limit the invention.

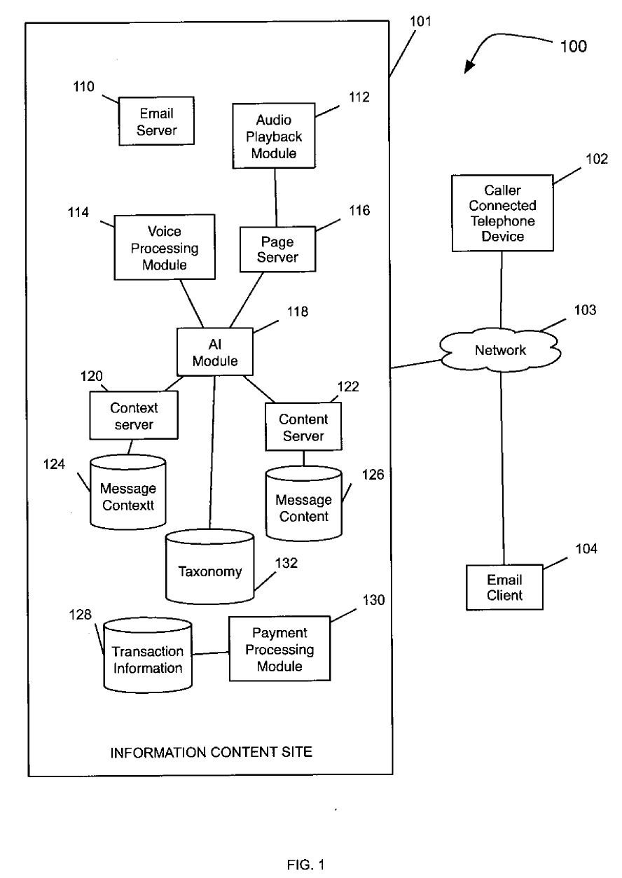

In FIG. 1, one embodiment of the present invention is illustrated 100, depicting the systems and devices involved, and some of their inter-relations; however, it should be noted that this diagram represents only one embodiment of certain aspects of the system, and there are other interactions that, for clarity's sake are not depicted. The caller's telephone 102 is connected through a network 103 to the information content site 101. An Artificial Intelligence (AI) module 118 works with a context server 120 and a content server 122 to provide content 126 for messages played for the user 112 through a data streaming page delivered by a page server 116. The AI module 118 also works with a voice processing module 114 to interpret the spoken responses from a caller, which provide both content 122 and context 120 to the AI module to use. The AI module uses taxonomy to associate content 122 with context 120. A transaction information storage area 128 and a payment processing module 130 are depicted, which store information gathered during a caller session and process credit card payments, respectively, are depicted as being a part of the information content site 101. Finally, an email server 110 within the information content site 101 provides purchase and download information from a transaction 128 through a network 103 to a caller's email client 104.

The message server contains an indexed array of data representing spoken messages. Messages are associated with content, and content is further associated with a context that is determined from a taxonomy representing the subject or subjects of the system as configured by the system administrators of a particular deployment. A taxonomy as used herein defines the relationship between content-related fields or collections of them, and context-related fields or collections of them. The taxonomy is represented in the system as a database, and it associates content in a given message with specific context categories. Further, it is worth noting that taxonomies are a type of commonly used artificial intelligence technology, and the details of the use of hierarchical taxonomies and the nodes of information comprising them will not be discussed in detail here, as they are well known in the art. The term “content context category” is used in the description in many places, and the Applicant wishes to describe this term as meaning the swath of operations through which a caller's spoken or otherwise response to a voice recognition system prompt is determined to be related to certain context categories for the content of the original message.

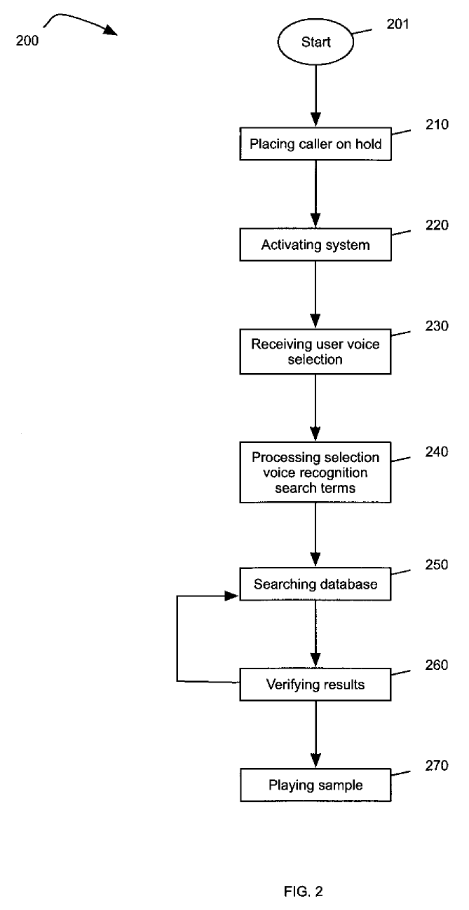

In FIG. 2, a caller enters 200 the system of the present invention after being placed on hold 210. The system is activated 220 and begins enumerating selections. The system then receives the user's voice selection 230, which is then processed 240 by the voice recognition system component to determine search terms. The database of the system disclosed herein 250 and returns results for verification 260. When the result has been verified, the selected sample is played 270.

The following is an exemplary dialog between the system and a caller being placed on hold when the system is activated 220. The system, once the call has been activated, greets the caller with a message, “Hello and thank you for calling the medical offices of Doctors Thrace and Valentine. Our staff is currently assisting other patients, and will be with you in a moment. Would you like to listen to some music while you wait? Just say ‘yes’ or ‘no.’” The caller then replies 230, “Yes.” At this point, a random selection of music is played 270.

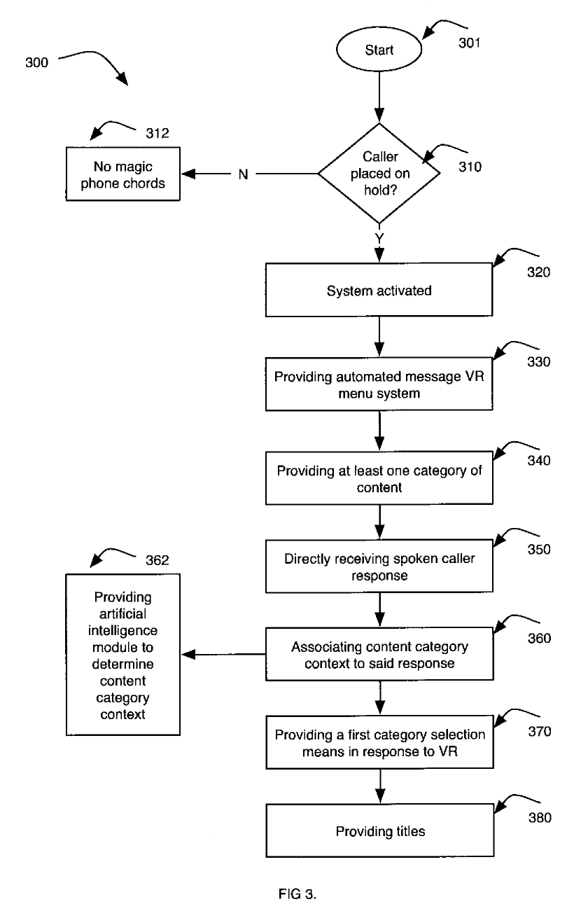

FIG. 3 describes a more detailed embodiment of the present invention. In the figure, a user enters 301 a call routing system employing the system of the present invention for callers placed on hold 310. If a caller is not placed on hold, the system is not activated 312, and continues being routed as necessary. If a caller is placed on hold 310, the content presentation system of the current application activates 320, and an automated message is provided through the menu system of said content presentation system 330. The automated message provides at least one category of content for the user to select from 340, and waits for the user to provide a spoken response. The caller's spoken response is received directly by the system 350. The voice data representing the useres response is then parsed and the parsed results scanned for keywords and phrases that are associable with the pre-configured content context categories available in the system. The voice response is processed, and is associated contextually 360 with the category of content by an artificial intelligence module which determines the context 362. Next, in response the voice recognition process, a means of selecting the first category is provided 370. Once these operations have completed, a selection of information content files is presented to the caller 380.

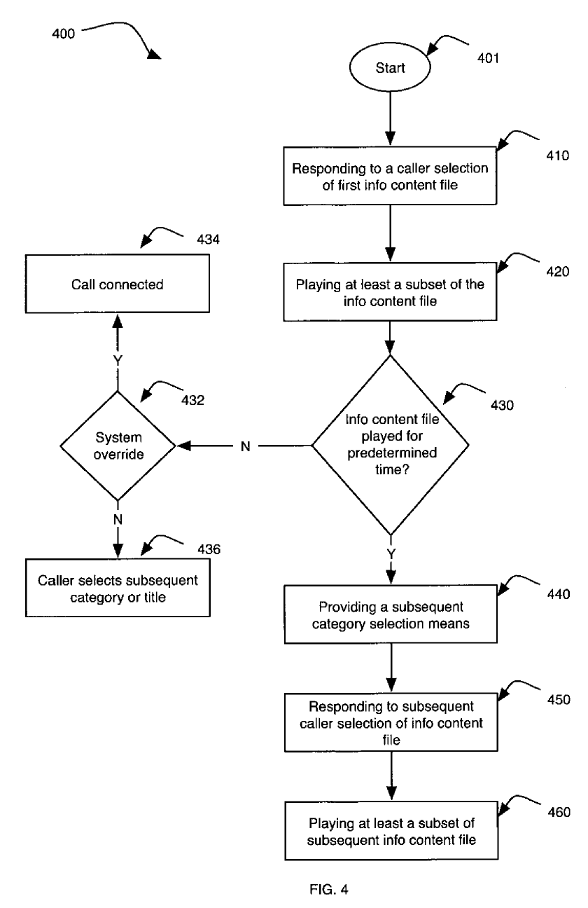

Continuing the exemplary embodiment of FIG. 3, FIG. 4 describes a method 400 to play content for a user, and begins once the caller placed on hold has selected 410 the desired file. Once the user speaks their response, the voice data provided is received directly by the system, as shown in FIG. 3 350. Now referring back to FIG. 4, the voice data representing the user's response is then parsed and the parsed results scanned for keywords and phrases that are associable with the pre-configured content context categories available in the system. The information file or subset thereof determined to be relevant from the caller's response is then played for the caller 420. If the selection is interrupted and does not play through for the entirety of a predetermined time 430, the call is connected 434 if the interruption stems from a system override by the call routing system hosting the system of the present invention. If the interrupt is user- or otherwise-driven, the caller is prompted to repeat the selection process 436; a means of selecting a subsequent category is presented 440, and the caller repeats the content file selection operation with the newly selected category 450. The contents of the newly selected file are played for the caller 460.

The following exemplary dialog excerpt is between the system and a caller on hold while being presented with an initial menu to selection from, and the resulting content context categories. The system finishes playing a random selection begun after an exemplary dialog above, which in this example is Rachmaninoff s Piano Concerto #3, played by L. Brian Manning. The system then prompts, as in FIG. 3 340 the caller, “We hope you enjoyed Rachmaninoff's Piano Concerto #3 performed by L. Brian Manning. Would you like to continue listening to classical music or another type? Please say ‘classical,’ ‘country,’ ‘folk’ or ‘popular.’” The caller replies, “Classical.” The system receives the response as shown in FIG.2 230, processes it, and, referring now to FIG. 3, associates it 360 with relevant information content in the context of the caller's response 362. The system then prompts 370 the user again asking, “Great! Would you like to hear more Rachmaninoff, or select another composer? Say ‘more’ or ‘another.’” The user replies, “More.”

Next, an exemplary dialog between the system and a caller on hold illustrates the operation of the system when having interrupted a playing selection before a predetermined time. Going back now to FIG. 4, the system, interrupting the currently playing selection or dialog-in-progress, announces 432, “Sorry to interrupt, but your call is being transferred. At the end of your call, you can ask to be transferred back here to continue your purchase. Please write down this code: 5AQ43. Simply enter it when prompted. Transferring your call now . . . ” The call is then transferred 434 to the staff attendant, who greets the caller, “Doctors Thrace and Valentine, how may I help you?” The caller replies, “This is Mr. Brown. I was calling to get my lab results.”

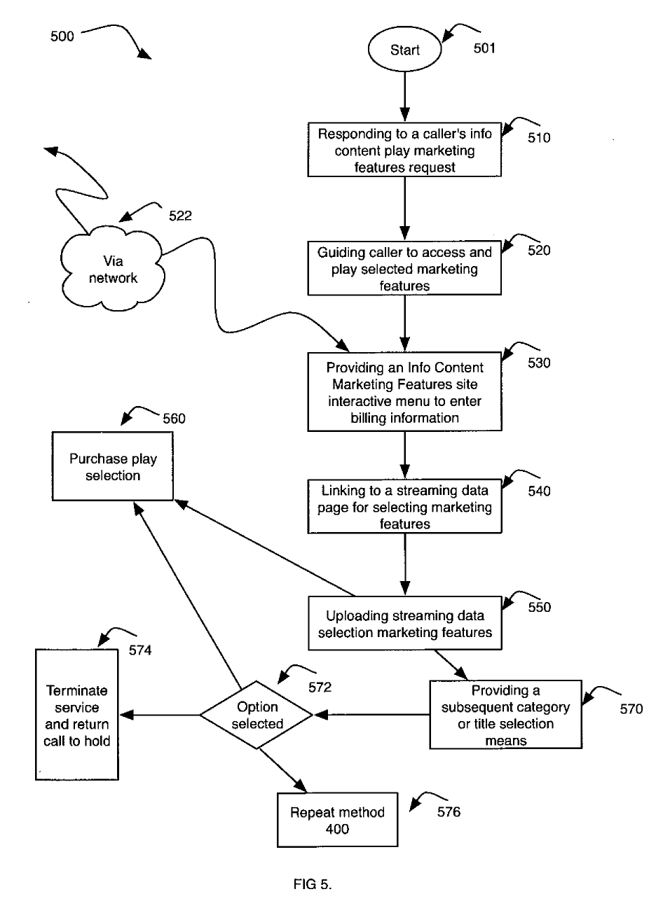

In FIG. 5, the system of the present invention responds 501 to a caller on hold's information content feature request 510, in this case, a music selection. The caller is then guided to access and play the preselected caller-requestable features 520. The features are then accessed through the network 522, and an interactive menu is presented to the caller on hold to enter billing information for the information content features site 530. The user selects from a predetermined set of features in a streaming data page 540 presented after they have completed the task of entering billing information. Selections made on the streaming data page between the various marketing features are then uploaded and processed 550, and the play selection purchased 560. If no selections presented to the user are selected, the caller is then prompted to continue in the interactive system of the present invention, or to be presented instead with non-interactive content and hold music. Once the transaction is complete, a subsequent category or title is presented to the caller for selection 570, and the caller has several options 572 at this time. The caller can purchase the subsequent selection 560, repeat method 400 to play selected content 576, or exit the system and return to hold 574.

The following dialog between the system and a caller on hold exemplifies the operation of the system when having played selection through to a predetermined time. Returning now to FIG. 4, in this dialog, the system, upon playing the audio track 430, announces 440, “We hope you enjoyed Rachmaninoff's Piano Concerto No. 2 played by Paul Smith. Would you like to hear more Rachmaninoff, another composer or hear other options? Just say ‘more,’ ‘composers’ or ‘options.’” The caller replies, “Options.” The system then receives and processes the user's answer 440 as before and then responds 450 informing the user, “You can purchase the selections you've heard today for digital download through our service, listen to reviews or select another type of music. If you prefer, you can just keep listening to Rachmaninoff. Just say ‘purchase,’ ‘reviews,’ ‘select’ or ‘more.’” The caller replies, “Purchase.”

Now disclosed in an exemplary dialog excerpt is the interaction between the system and a caller on hold entering billing information before selecting possible options for purchase. We enter the dialog at a point where the system has asked caller if they would like to purchase music selections, and the caller is now entering billing information at the system's prompting. The system asks, “Please say your first name.” To which the caller replies, “Parker.” The system then asks, “You said, ‘Parker.’Is this correct?” To which the caller replies, “Yes.” Then, the system asks, “Please say your last name.” To which the caller replies, “Smith.” Next, the system asks, “Please provide your credit card number.” To which the caller replies, “1234 5678 9123 4567.” The system then prompts, “Please provide your billing address with street, city, state and zip code.” To which the caller replies, “1234 Main Street, Anytown, Calif. 12345.” Next, the system asks, “Please provide your email address.” The caller replies, “Parker.Smith@ParkerSmith.com.” Finally, the system says, “Thank you! Selections you purchase today will be available through a digital download. Details on how to retrieve your purchased selections will be mailed to this email address.””

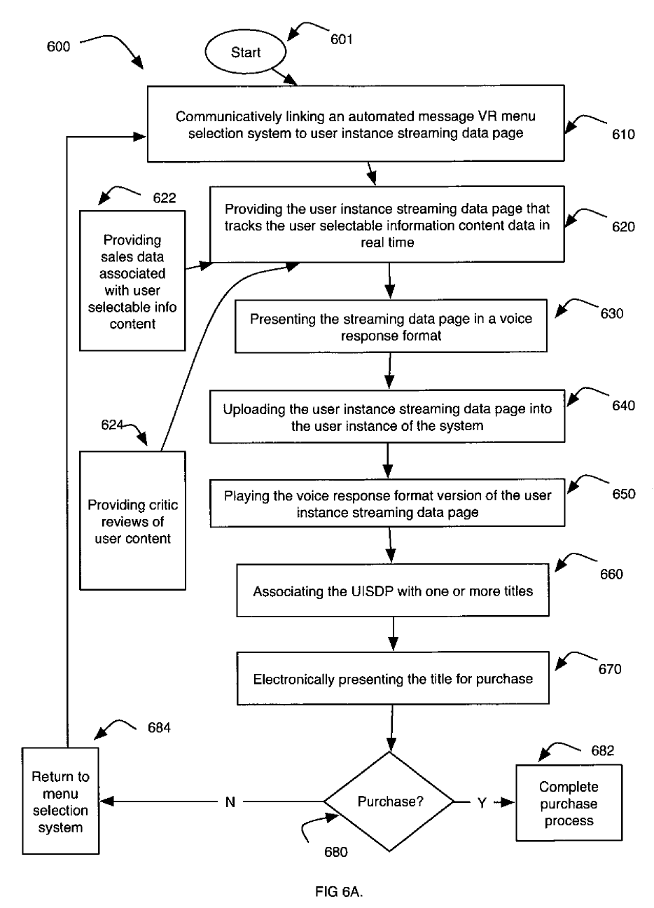

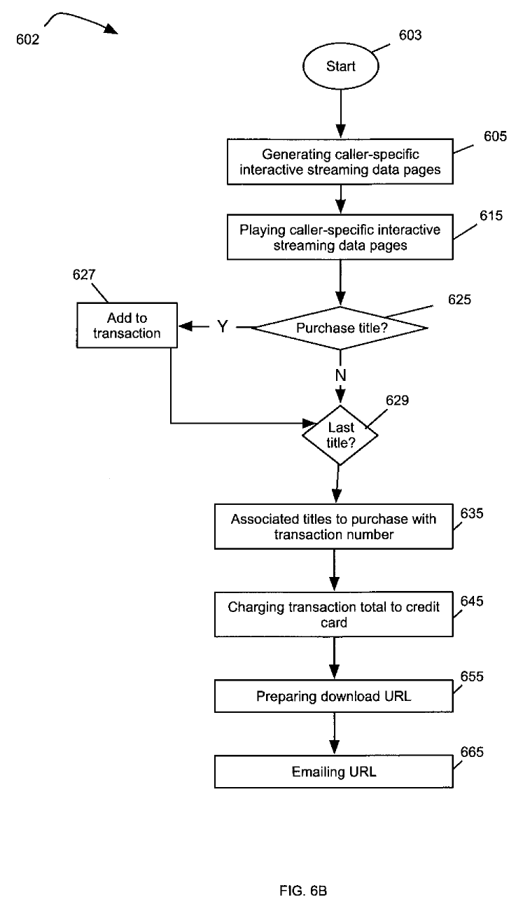

More detail regarding the streaming data page of FIG. 5 540 is disclosed in FIG. 6A, wherein the method 600 starts 601 when a caller-specific instance of a streaming data page is communicatively linked to an automated message menu selection system using voice recognition facilities 610. The caller-specific streaming data page then tracks the caller-selectable information content data in real-time 620, along with the sales data associated with the caller-selectable information content 622, and critic reviews 624. The streaming data page is presented in a voice response format 630, and subsequently uploaded into the user instance of the system of the present invention 640. The voice response format version of the caller-instance streaming data page is then played for the caller 650. Once the streaming data page has been played for the caller, one or more titles are then associated with the callers caller-specific streaming data page 660. The user is prompted to select one or none of the presented titles. After the first title is selected, the caller is again prompted to select one or none of the remaining original titles or any additional titles added to the list of selectable titles by the system heuristically as the caller's preferences become more clearly defined through selection behaviors. This presentation-selection cycle proceeds until the user selects none, or until the system has presented the predetermined maximum number of title lists. The titles are then electronically presented for purchase 670. The user then makes the decision 680 to purchase or not purchase each title. If the caller chooses not to purchase any, they are returned to the menu selection system of 610 as described above. If they purchase selected titles, the purchase is completed 682.

FIG. 6B discloses greater detail 602 on the method to verify titles for purchase previously presented content. To complete a purchase, the system of the present invention generates a caller-specific interactive streaming data page 605 which, when played 615, prompts the user to verify for purchase 625 one of the titles played for the caller of the one to many selections from previous menus. This step is repeated 629 for each title that was played for the caller. Once all selections have been verified in the positive 627 or negative sense, those titles positively identified for purchase are associated 635 with a transaction number, and are charged 645 to the user-supplied credit card information previously entered as detailed in an exemplary dialog excerpt above. Independently of any caller action, once the purchase is completed, the system prepares a user-specific URL enabling the user to download the purchased selection(s) 655, and generates and sends an email to the user-supplied address 665 entered as detailed in an exemplary dialog excerpt above.

Finally, presently illustrated is an exemplary dialog between the system and a caller on hold verifying elections for purchase. In this scenario, the user is given a voice prompt containing the song title of each selection he heard and must indicate whether he would like to include that title in his purchase; the voice prompt is generated by a caller-specific interactive streaming data page 605. The system prompts 615, “Here are the selections you enjoyed today. Please indicate for each whether you'd like to include this in your purchase today by saying ‘Purchase’ or ‘No, thanks.’ Rachmaninoff's Piano Concerto No. 3?” The caller replies, “Purchase.” The system receives the voice response and processes it 350, then responds 360, 605, 615, “Added to your cart. Rachmaninoff's Piano Concerto No. 2?” The caller replies, “No, thanks.” The system receives the voice response and processes it 350, then responds 360, 605, 615, “Discarding. Prelude Op. 3, No. 2?” The caller replies, “Purchase.” The system then receives the voice response and processes it 350, then responds 360, 605, 615, “Added to cart. Thank you. You have selected two titles for purchase today through a digital download. Details on how to retrieve your purchased selections will be mailed to this email address.”” Further, the system announces 635, 645, “Your purchases today will be charged to the credit card you supplied, and will show as THRACEVALHOLDMUS on your card statement.”

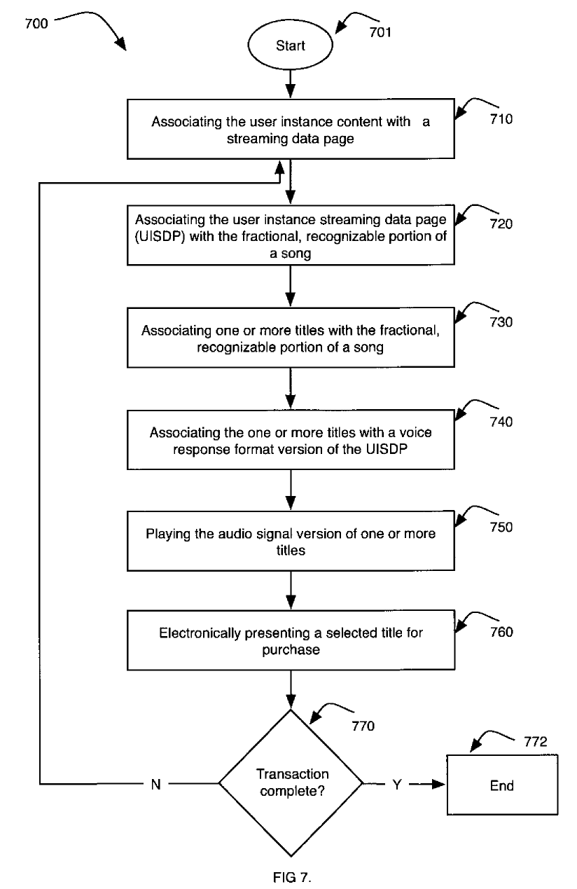

FIG. 7 describes 360 of FIG. 3 in greater detail. Once the user instance information content has been associated with the streaming data page 710, a fractional but recognizable portion of a song is associated with the caller-specific instance of the streaming data page 720. Once that operation is complete, one or more titles are then associated with the fractional, but recognizable portion of the song 730. Finally, the one or more titles are associated with a voice response format version of the caller-specific streaming data page 740, and the resulting audio signal version of the one or more titles is played for the caller 750. Once the title or titles have been played, a selected title is presented for purchase electronically 760. Once the purchase is complete 770, the transaction is ended 772, or if the purchase is not complete, the steps of the present method are repeated starting at 710.

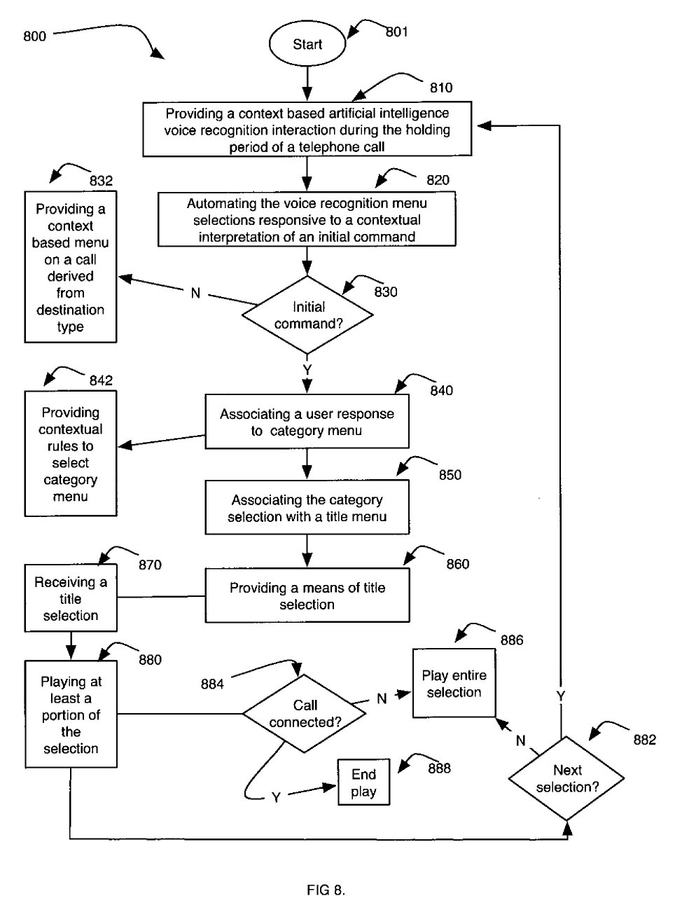

The operations of the artificial intelligence module of FIG. 3 362 are disclosed in further detail in FIG. 8, and the method picks up at 801. An interaction with the artificial intelligence voice recognition module occurs 810, after which voice recognition menu selections are automated 820, which are responsive to a contextual interpretation of an initial command. If the present command has not been preceded by another 830, then the system of the present disclosure provides a context-based menu 832 on a call derived from the destination type. If, on the other hand, the command is not preceded by another, then the system associates, as described above, a caller response to a category menu 840. At this time then, the system provides contextual rules to select a category menu 842, and associates a category selection with a title menu 850. The caller is then presented with a means of selecting a title 860, described previously. The caller then selects a title 870, also described in detail above, and at least a portion of the selection is played 880. If the call is connected 884, then the selection ceases to play 888. If the call is not connected 884, the entire selection is played for the caller 886.

What is claimed is:

1. A method for providing user selectable information content while holding on a telephone call, comprising:
providing an automated message voice recognition menu selection system;
activating said system when a caller is placed on hold;
directly providing at least one category of user selectable information content;
directly receiving a spoken voice recognition response by the caller;
associating a user selectable information content category context to said spoken voice recognition response;
providing a user selectable context category selection means in response to said spoken voice recognition response;
responsive to said category selection, providing one or more information content titles wherein said content titles represent information files including fractional samples of information content; and
responding to a caller selection of a first information content file, playing said information content sample associated with said first information content title for a predetermined period of time wherein said first information content title may be terminated early at the option of the caller and a subsequent information content title may be selected and the associated sample be played.

2. The method of claim 1 for providing user selectable information content while holding on a telephone call, further comprising:
responding to a caller selection of a first information content file; and
playing said information content sample or entire title associated with said first information content title for a predetermined period of time wherein said first information content title may be terminated early at the option of the caller and a subsequent information content title may be selected and the associated sample be played.

3. The method of claim 2, further comprising:
guiding a caller to enter billing and shipping information upon decision to buy; and
terminating the first or the subsequent selected information content title sample when the call is transferred to the intended meantime available recipient on demand of the caller.

4. The method of claim 3, further comprising:
receiving an interactive voice recognition automated message set; and
transmitting a keypad touch message set in response to an interactive recognition automated message set.

5. The method of claim 1, further comprising:
guiding a caller to enter billing and shipping information upon a decision to buy; and
terminating an interactive voice recognition automated message set automatically when the call on hold is transferred to its recipient.

6. A computer-usable medium having computer-readable program code embodied therein for controlling a processor to provide user selectable information content while holding on a telephone call, said code including instructions to:
provide an automated message voice recognition menu selection system;
activate said system when a caller is placed on hold;
provide at least one category of user selectable information content;
select a category of user selectable information content;
select information content titles wherein said content titles represent an information file selected from said user selected category;
play said user selected information content titles for a dispersed, predetermined period of time wherein said user selected information content title may be terminated early at the option of the user and a subsequent selected information content title may be played;
guide caller to enter billing and shipping information upon decision to buy; and
terminate the subsequent selected information content title when the call is transferred to the intended recipient.

7. A computer-readable medium for providing user selectable information content while holding on a telephone call, comprising:
program code for providing an automated message voice recognition menu selection system while a user is on hold during a telephone call;
program code for activating said system when a caller is placed on hold;
program code for providing at least one category of user selectable information content;
program code for selecting a category of user selectable information content;
program code for selecting information content titles wherein said content titles represent an information file selected from said user selected category;
program code for playing said user selected information content titles for a predetermined period of time wherein said user selected information content title may be terminated early at the option of the user and a subsequent selected information content title may be played;
program code for guiding a caller to enter billing and shipping information upon a decision to buy; and
program code for terminating the subsequent selected information content title when the call is transferred to the intended recipient.

8. A computer-readable medium for providing user selectable information content while holding on a telephone call, comprising:
program code for providing an automated message voice recognition menu selection system;
program code for activating said system when a caller is placed on hold;
program code for directly providing at least one category of user selectable information content;
program code for directly receiving a spoken voice recognition response by the caller;
program code for associating a user selectable information content category context to said spoken voice recognition response;
program code for providing a user selectable context category selection means in response to said spoken voice recognition response; and
program code for responding to said category selection, providing one or more information content titles wherein said content titles represent information files including fractional samples of information content.

9. The computer-readable medium of claim 8 wherein said fractional samples of information content is a recognizable portion of a song.

10. A system for providing user selectable information content while holding on a telephone call, the system including a processor operable to execute instructions and a data storage medium for storing the instructions that, when executed by the processor, cause the processor to perform the method comprising:
providing an automated message voice recognition menu selection system while a user is on hold during a telephone call;
activating said system when a caller is placed on hold;
providing at least one genre of user selectable information content;
selecting a genre of user selectable information content;
selecting information content titles wherein said content titles represent an information file selected from said user selected genre wherein the information content titles includes abbreviated samples of user selected information content titles from one or more user selected genres;
playing said user selected information content titles for a predetermined period of time wherein said user selected information content title may be terminated early at the option of the user and a subsequent selected information content title may be played; and
terminating the subsequent selected information content title when the call is transferred to the intended recipient.

11. The system of claim 10, further comprising:
guiding a caller to enter billing and shipping information upon a decision to buy; and
terminating the subsequent selected information content title when the call is transferred to the intended recipient.

12. A computer-implemented apparatus for providing user selectable information content while holding on a telephone call, said apparatus comprising:
a processor;
an input device coupled to said processor;
a memory coupled to said processor;
an execution engine including instructions executable by said processor, said instructions being configured for providing user selectable information content while holding on a telephone call; and
an output device.

13. The method of claim 1, further comprising:
providing the automated message voice recognition menu selection system while a user is on hold during a telephone call wherein said system is communicatively linked to a streaming data page tracking data, including information content sales and critic reviews of said information content, said streaming data page uploadable into the user instance of the system.

14. The method of claim 7, further comprising:
providing the streaming data page tracking data automatically into a user instance of the system.

15. A system for providing user selectable information content while holding on a telephone call, the system including a processor operable to execute instructions and a data storage medium for storing the instructions that, when executed by the processor, cause the processor to perform the method comprising:
